(19) United States
(12) Patent Application Publication
(10) Pub. No.: US 2009/0274605 A1
(43) Pub. Date: Nov. 5, 2009

(54) CONTINUOUS SILAZANE CLEAVAGE METHOD

(75) Inventors: Martin Jansen, Leonberg (DE); Grigorios Kolios, Stuttgart (DE); Britta Jaeschke, Stuttgart (DE)

Correspondence Address: ROTHWELL, FIGG, ERNST & MANBECK, P.C., 1425 K STREET, N.W., SUITE 800, WASHINGTON, DC, 20005, US

(73) Assignee: Max-Planck-Gesellschaft zur Foerderung der Wissenschaften e. V., Muenchen (DE)

(21) Appl. No.: 11/721,632

(22) PCT Filed: Dec. 13, 2005
(86) PCT No.: PCT/EP05/13384

§ 371 Date: Jun. 13, 2007

(30) Foreign Application Priority Data
Dec. 13, 2004 (DE) 10 2004 059 942.4

(51) Int. Cl. C01B 35/14; C07F 7/02

(52) U.S. Cl. 423/284; 556/402

(57) ABSTRACT

The invention relates to a continuous silazane cleavage method, especially for use in the production of molecular precursors for non-oxidic inorganic ceramics.

The present invention relates to a continuous silazane cleavage method, in particular for the production of molecular precursors for non-oxide inorganic ceramics.

Silazane cleavage reactions which are carried out batchwise have already been described in the prior art (Metallo-organicheskaya Khimiya (1989), 2 (3), 701-2, Kalikhman, I. D. et al.; Journal of Organometallic Chemistry (1989), 361(2), 147-55, Kalikhman, I. D. et al.; Zhurnal Obshchei Khimii (1981), 51(8), 1824-9, Sheludyakov, V. D. et al.).

Ceramics prepared from the anionic components C and N together with 2 to 4 further elements such as B, Al, Ga, In, Si, Ge, P, Ti, Zr, V, Nb, Ta, Cr, Mo, W, Fe or Zn having a cationic function are of particular interest. Such ceramics, for example consisting of Si, B, N and C, are distinguished by excellent thermal, mechanical and chemical resistance and, in terms of their combination of all applicational properties, are distinctly superior to competing materials, for example for use in heat engines. A prerequisite for achieving these advantageous properties is the creation of a network with a regular alternation of elements with an anionic and cationic function, the latter homogeneously distributed over zones of above 1 to 2 nm.

Such prerequisites may be achieved by the synthesis and provision of molecular single component precursors, which contain the particular desired combination of cationic components linked to one another via nitrogen. These molecular precursors are then polymerised and finally ceramised by pyrolysis. Since the polymeric intermediate stages may be processed using any polymer processing method, an unusually wide range of forms of use is accessible, such as for example fibres, films, infiltrates, coatings and mouldings. The potential of this new family of materials for the production of fibre-reinforced ceramic composites is of particular significance. Unequalled properties at elevated temperatures in air and with simultaneous mechanical loading are the guarantee of potential applications. Penetration into areas occupied by metallic and conventional ceramic materials is desirable due to the numerous technical advantages, but only possible if an inexpensive production process is available.

The review article “Amorphous Multinary Ceramics in the Si—B—N—C System” (M. Jansen et al., Struct. Bond. 2002, 101, 137) and DE 41 07108 A1, DE 100 45 427 A1, DE 100 45 428 A1 and 101 04 536 A1 describe syntheses for the Si/B/N/C subsystem for the variants of the molecular scaffold for a single component precursor of the formula (1) RₓHal₃₋ₓSiNR¹—BR_{y}Hal_{2-y} wherein R in each case independently represents a hydrocarbon residue with 1 to 20 C atoms, Hal in each case independently means Cl, Br or I, R¹ in each case independently represents a hydrocarbon residue with 1 to 20 C atoms or hydrogen, x=0, 1 or 2 and y=0 or 1.

A feature which is common to the above-described methods is that the particular target molecule is synthesised in batch mode starting from Me₃Si—NR¹SiMe₃ by two successive silazane cleavage reactions, firstly with SiHal₄₋ₓRₓ, then with BHal_{3-y}R_{y}.

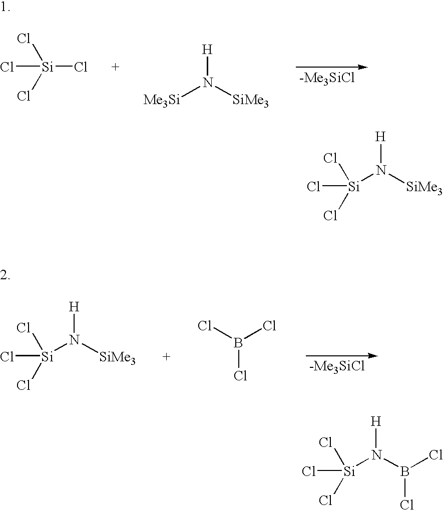

These are laboratory syntheses which cannot straightforwardly be carried out as environmentally and economically optimised production methods on an industrial scale.

The following may in particular be problematic:
1. Reaction times for the first silazane cleavage are between 20 and 48 hours, for the second approx. 12 hours per batch. Satisfactory space-time yields thus cannot be achieved via this route.
2. If reaction temperatures are increased, selectivity declines and undesired secondary products such as RₓHal₃₋ₓSi—NR¹—SiHal₃₋ₓRₓ or Me₃Si—NR¹—SiHal₂₋ₓRₓ—NR¹—SiMe₃ may be formed.
3. Large excesses of costly feed materials have hitherto been necessary, the costs of which impair the economic viability of the method.
4. Synthesis by the “batch” method is comparatively uneconomic, since each reaction batch is preceded by a time-consuming and costly provision of an inert atmosphere in the reaction apparatus.
5. High costs are generated by the necessary cooling during synthesis and by the isolation and purification of the product by distillation processes.
DE 100 45 428 A1 describes an alternative preparative route to yield the above defined single component precursors, according to which an amine component R¹NH₂ is reacted in succession with a silane component SiHal₄₋ₓRₓ and a borane component BHal_{3-y}R_{y}:

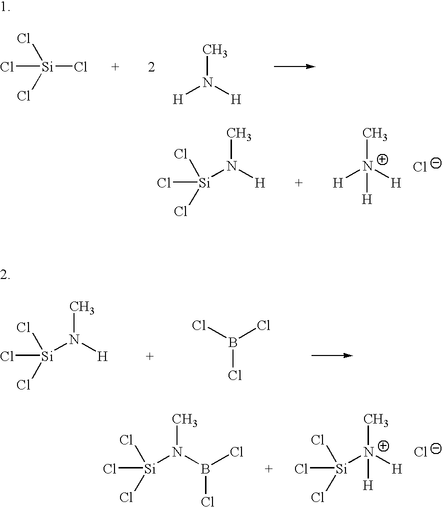

In this sequence of two successive aminolysis reactions, the formation of difficult to separate saline hydrochlorides, which inevitably occurs in both steps, is disadvantageous and additionally considerably diminishes product yield relative to the introduced material. Nonetheless, this approach has made it possible to achieve a continuous production method, in which the reactor is cycled between a production phase and a regeneration phase (stripping of hydrochlorides) (DE 102 28 990 A1).

While the described method already yields good results, it still exhibits disadvantages from a technical and economic standpoint:
1. The space-time yield is reduced by the intermittent mode of operation. The only remedy is to install a parallel reactor (so increasing capital investment).
2. Half of the amine starting component and half of the silylamine intermediate stage are bound as hydrochlorides and discharged during the regeneration cycle. This considerably reduces the yield of final product relative to the valuable feed materials.
3. The target products require elaborate isolation and purification.
4. Residues of intermediate and final product are pyrolysed during thermal stripping and accordingly result in reactor fouling over long-term operation.

Many compounds of interest and in particular molecular single component precursors for non-oxide ceramics may be produced by silazane cleavage. Hitherto known batch methods, however, exhibit the disadvantages discussed above it was accordingly an object of the present invention to provide a method for cleaving silazane compounds which at least partially overcomes the disadvantages of the prior art.

A further object of the present invention was to provide an efficient, generally applicable method for the production of single component precursors for non-oxide ceramics which should in particular satisfy the following requirements:

it should be possible to carry out the method continuously, without separate isolation or storage of the intermediate stage.

product yield should be optimal, such that the feed materials are converted as completely as possible into the product.

The invention relates to a method for cleaving silazane compounds, which is characterised in that it is carried out continuously. It has surprisingly been found that silazane cleavage may be carried out continuously, so making it possible to overcome the above-stated disadvantages with regard to a poor space-time yield.

Silazanes are silicon-nitrogen compounds which comprise an Si—N bond. Element-N compounds can be synthesised by silazane cleavage.

It has furthermore been found according to the invention that a continuous mode of operation of the method is in particular advantageous and possible if at least one of the educts introduced for silazane cleavage is used in gaseous form. The silazane or the cleaving reagent or both may here be introduced in gaseous form. In a preferred embodiment, all the educts are introduced in gaseous form and the reaction proceeds in the gas phase. In a further preferred embodiment, at least one educt is introduced in gaseous form and at least one other educt is introduced in liquid form. When this approach is use, the method is advantageously performed countercurrently, whereby it is possible to achieve conversion which is virtually quantitative or even quantitative. When the reaction is carried out in this manner, at least one reaction stage advantageously takes the form of a gas-liquid reactor, for example a bubble column, spray column, packed column, falling-film reactor or reactor with external recirculation.

A further improvement of the continuous method according to the invention may be achieved by removing the target product and/or undesired secondary products from the reaction mixture and thus from the equilibrium. The target product may be isolated from the remaining components of the reaction mixture for example by crystallisation, condensation and/or using a solvent. Secondary products, in particular highly volatile secondary products, are preferably removed from the reaction mixture by partial condensation, distillation, pervaporation, gas permeation or adsorption. Phase separation between the condensate phase and gas phase preferably proceeds in an inertial separator or in a cyclone. Using the continuous mode of operation of the method according to the invention, it is in particular possible to achieve elevated selectivity with regard to the desired target products. Selectivity may further be ensured by carrying out the reaction with one of the educts in excess, in particular in an at least 1.5 times, more preferably an at least 2 times excess.

Overall, using the continuous method according to the invention, the feed materials may be virtually quantitatively converted into the desired target compounds. In a preferred embodiment of the present invention, the silazane cleavage described herein is used to produce compounds having the structural feature N—Y. The invention therefore also relates to a continuous method comprising silazane cleavage, as described above, for the production of a compound which comprises the structural feature N—Y, in which Y is in each case independently selected from B, Al, Ga, In, Si, Ge, P, Ti, Zr, V, Nb, Ta, Cr, Mo, W, Fe or Zn, wherein a silazane compound is reacted with a compound of the formula (2) selected from BHal₃₋ₓRₓ, AlHal₃₋ₓRₓ, GaHal₃₋ₓRₓ, InHal₃₋ₓRₓ, SiHal_{4-y}R_{y}, GeHal_{4-y}R_{y}, PHal₃₋ₓRₓ, PHal_{5-z}R_{z}, TiHal_{4-y}R_{y}, ZrHal_{4-y}R_{y}, VHal₃₋ₓRₓ, VHal_{4-y}R_{y}, NbHal_{5-z}R_{z}, TaHal_{5-z}R_{z}, CrHal₃₋ₓRₓ, MoHal_{4-y}R_{y}, MoHal_{5-z}R_{z}, WHal_{6-z}R_{z}, FeHal₃₋ₓRₓ or ZnCl₂ in which x=0 or 1, y=0, 1 or 2 and z=0, 1, 2 or 3, Hal is selected from F, Cl, Br and I, and R represents hydrogen or a hydrocarbon residue with 1 to 20 C atoms.

One particularly preferred embodiment is a continuous method for the production of a compound which comprises the structural feature X—N—Y, in which X and Y in are each case independently selected from B, Al, Ga, In, Si, Ge, P, Ti, Zr, V, Nb, Ta, Cr, Mo, W, Fe or Zn, comprising the steps reacting a silazane compound, in particular a compound of the formula (3) R²₃SiNR¹SiR³₃,

in which R² and R³ in each case mutually independently represent a hydrocarbon residue with 1-20 carbon atoms and R¹ represents hydrogen or a hydrocarbon residue with 1-20 C atoms,
in succession in any desired order with a compound of the formula (2), selected from
BHal₃₋ₓRₓ, AlHal₃₋ₓRₓ, GaHal₃₋ₓRₓ, InHal₃₋ₓRₓ, SiHal_{4-y}R_{y}, GeHal_{4-y}R_{y}, PHal₃₋ₓRₓ, PHal_{5-z}R_{z}, TiHal_{4-y}R_{y}, ZrHal_{4-y}R_{y}, VHal₃₋ₓRₓ, VHal_{4-y}R_{y}, NbHal_{5-z}R_{z}, TaHal_{5-z}R_{z}, CrHal₃₋ₓRₓ, MoHal_{4-y}R_{y}, MoHal_{5-z}R_{z}, WHal_{6-z}R_{z}, FeHal₃₋ₓRₓ or ZnCl₂ in which x=0 or 1, y=0, 1 or 2 and z=0, 1, 2 or 3, Hal is selected from F, Cl, Br and 1, and R represents hydrogen or a hydrocarbon residue with 120 C atoms,
and a compound of the formula (4) selected from
BHal₃₋ₓRₓ, AlHal₃₋ₓRₓ, GaHal₃₋ₓRₓ, InHal₃₋ₓRₓ, SiHal_{4-y}R_{y}, GeHal_{4-y}R_{y}, PHal₃₋ₓRₓ, PHal_{5-z}R_{z}, TiHal_{4-y}R_{y}, ZrHal_{4-y}R_{y}, VHal₃₋ₓRₓ, VHal_{4-y}R_{y}, NbHal_{5-z}R_{z}, TaHal_{5-z}R_{z}, CrHal₃₋ₓRₓ, MoHal_{4-y}R_{y}, MoHal_{5-z}R_{z}, WHal_{6-z}R_{z}, FeHal₃₋ₓRₓ or ZnCl₂ in which x=0 or 1, y=0, 1 or 2 and z=0, 1, 2 or 3, Hal is selected from F, Cl, Br and I, and R represents hydrogen or a hydrocarbon residue with 1-20 C atoms. In this embodiment, two silazane cleavage reactions are carried out. In these two reactions, the compounds of the formulae (3) and (4) are preferably present in gaseous form.

It has surprisingly been found the method for the production of molecular single component precursors for non-oxide ceramics may be carried out continuously. The reaction of the silazane compound with a compound of the formula (2) preferably proceeds in the gas phase. Alternatively, one of the two reactants may be introduced in the form of a liquid. In this case, the compound of the formula (3) is preferably present in the liquid phase and the compound of the formula (2) in the gaseous phase. The product of silazane cleavage is obtained in liquid form, whereby the desired products may be produced inexpensively and on a large scale. The method according to the invention for the production of compounds with the structural feature X—N—Y, in particular of compounds with the formula (1) RₓHal₃₋ₓSi—NR¹BR_{y}Hal_{2-y} proceeds via a two-fold silazane cleavage from R²₃SiNR¹SiR³₃ (3).

In formula (3), R² and R³ may preferably in each case independently mean an alkyl and/or aryl residue with 1-7 C atoms, preferably a methyl residue.

The silazane cleavage according to the invention and in particular the reaction of a compound of the formula (3) with a compound of the formula (2) preferably proceeds at temperatures of −100° C. to 300° C., more preferably at temperatures of >25° C. and <100° C., still more preferably at temperatures of ≧50° C. and <70° C., and most preferably at temperatures ≧55° C. and ≦65° C. Furthermore, a suitable pressure is established to ensure that the compound of the formula (3), is liquid or gaseous as required, and the compounds of the formulae (2) and (4) are gaseous, wherein pressures of 0.1 mbar to 2 bar, in particular of 1 mbar to 1 bar are conventionally used. Under these conditions, the intermediate of the first silazane cleavage or the final product obtained by the second silazane cleavage are in each case obtained in liquid form.

In order to achieve a maximally quantitative conversion into the desired products, the silazane compound, in particular a compound of the formula (3), is preferably reacted with an excess of compounds of the formula (2) and/or a excess of compounds of the formula (4). Compounds of the formula (2) and/or compounds of the formula (4) are preferably introduced in an amount of at least 1.1 times, more preferably at least 1.2 times, still more preferably at least 1.5 times, and most preferably at least 2 times greater than the silazane compound.

In a preferred embodiment of the method according to the invention, pressure and temperature are adjusted such that the educts (2) and (4) are in gaseous form, but the educt (3), intermediate and final product are in liquid form. In this mode of operation of the method, the intermediate or final product may straightforwardly be separated from the method in condensed form. Separation may, for example, proceed by crystallisation, condensation and/or the use of a solvent. The product is preferably separated and recovered from the equilibrium by condensation.

The mode of operation of the method furthermore preferably proceeds in such a manner that secondary products, to the extent that any are formed, are removed from the reaction mixture. One secondary product often formed during the reaction is R₃SiHal, for example Me₃SiHal. Pressure and temperature are therefore suitably adjusted such that the partial pressure of a secondary products R₃SiHal formed during the reaction is lower than the saturation vapour pressure thereof, such that the secondary product is thus in gaseous form. Such gaseous secondary products may be separated in straightforward manner, for example by partial condensation, distillation, pervaporation, gas permeation or adsorption.

Isolation of the reaction product or separation of secondary products may advantageously proceeds by means of phase separation between the condensate phase and gas phase, for example in an inertial separator or in a cyclone.

In a preferred embodiment, the method according to the invention is carried out as a reactive distillation.

It is furthermore preferred to convert one educt quantitatively in the liquid phase countercurrently with a second educt in the gaseous phase. Preferably, one or both reaction stages are carried out as gas-liquid reactions, wherein suitable reactors may be for example bubble columns, spray columns, packed columns, falling-film reactors or reactors with external recirculation.

The compounds with the formulae (2) and (4) are preferably reacted in gaseous form. It is furthermore preferred to carry out the synthesis in a two-stage reaction process, in which both reaction stages proceed in the gas phase.

In order to achieve maximally quantitative conversion of the feed materials into the target compounds, unreacted feed materials or educts are advantageously returned to the process.

The invention in particular relates to a continuous mode of operation of two or more successive silazane cleavage reactions in a circuit of closed flow apparatuses without intermediate isolation or storage of the intermediate. The only secondary product to arise is R²₃SiCl or R³₃SiCl, which, by reaction with R¹NH₂, may be returned into the educt R²₃SiNR¹SiR³₃. One particularly advantageous aspect of the method according to the invention is that no salts arise as secondary products.

In a preferred embodiment of the invention, in the first stage, a compound of the formula (2), preferably SiHal₄₋ₓRₓ, reacts with a silazane compound, in particular a compound of the formula (3), preferably Me₃SiNR¹SiMe₃, in the gas phase or in a gas phase-liquid phase reaction at temperatures of −100° C. to 300° C., in particular of 25 to 100° C. and preferably of ≧55° C. to ≦65° C., and pressures in the reaction volume of 0.1 mbar to 2 bar, and specifically in each case under p/T conditions, under which the compound of the formula (2) is gaseous and the compound of the formula (3) is gaseous or liquid, but the saturation vapour pressure of the particular reaction product is exceeded and the latter is therefore condensed as a liquid, so being withdrawn from the homogeneous equilibrium and, once separated by a phase separator, fed into the next stage.

In a second stage, the intermediate is then reacted with a compound of the formula (4) and specifically preferably under p/T conditions, under which the compound of the formula (4) is gaseous and the intermediate is liquid. The second stage is preferably carried out at temperatures of −100° C. to +30° C.

The invention is based on the observation that the described type of reaction may surprisingly be carried out with elevated selectivity even at elevated temperatures. According to the invention, this is preferably achieved by two measures:
1. An excess compound of the formula (2), preferably SiHal₄₋ₓRₓ, is always present in the reaction volume, such that the two-fold amination, for example to yield Me₃Si—NR¹—SiHal₂₋ₓRₓ—NR¹—SiMe₃ (x=0.1) is suppressed.
2. The desired intermediate, for example Hal₃₋ₓRₓSiNR¹SiMe₃ is efficiently drawn off as a liquid phase or removed from the gas phase by condensation and in this way an undesired further reaction to yield Hal₃₋ₓRₓSiNR¹SiRₓHal₃₋ₓ is stopped.

If the difference in the boiling points of the feed material of the formula (2), for example SiHal₄₋ₓRₓ, and of the corresponding secondary product, for example Me₃SiHal is sufficiently large, a condenser is located at the top of the reaction volume, on which the feed material of the formula (2), for example SiHal₄₋ₓRₓ, which has been added in excess, is separated and the secondary product, for example Me₃SiHal, is allowed to pass through in gaseous form. The educt recovered after separation of the phases, for example SiHal₄₋ₓRₓ, is conveyed back into the reactor. In steady-state operation, fresh compounds of the formula (3), for example Me₃SiNR¹SiMe₃, and of the formula (2), for example SiHal₄₋ₓRₓ, are then supplied to the reactor in the same amount per unit time as the secondary product, for example Me₃SiHal, is removed from the reactor.

If, on the other hand, the boiling points of the feed material of the formula (2), for example SiHal₄₋ₓRₓ, and of the secondary product, for example Me₃SiHal, are very close to one another, the very different molar masses of these components (for example, molar mass of SiCl₄: 169.9; molar mass of Me₃SiCl: 108.6) may sensibly be exploited for the separation thereof. Suitable methods for this purpose are membrane methods using porous membranes or adsorption onto molecular sieves. In this case, such a suitable separation stage firstly adjoins the top of the reactor, in which the sub-stream enriched with educt, for example SiHal₄₋ₓRₓ, is condensed and returned to the process. Fresh educt, for example SiHal₄₋ₓRₓ is fed into the process in a molar quantity per unit time which corresponds to the cumulated quantity of discharged educt, for example SiHal₄₋ₓRₓ, and secondary product, for example Me₃SiHal, while fresh compounds of the formula (3), for example Me₃SiNR¹SiMe₃, are supplied to the reactor in the same amount per unit time as the secondary product, for example Me₃SiHal, is removed from the reactor.

The intermediate, for example Hal₃₋ₓRₓSiNR¹SiMe₃, is introduced into the second reaction stage in gaseous or liquid form and reacted with an excess of compounds of the formula (4), for example BCl₃. The pressure and temperature in the reactor are suitably adjusted such that the partial pressure of the secondary product, for example Me₃SiHal, is lower than the saturation vapour pressure thereof. In particular, temperatures of −100° C. to 300° C. and pressures of 0.1 mbar to 2 bar satisfy the stated requirements for p/T conditions. Secondary product, for example Me₃SiHal, and excess compounds of the formula (4), for example BCl₃, are drawn off from the top of the reactor. The secondary product, for example Me₃SiHal, is condensed and reused for the production of the starting materials of the formula (3), for example Me₃SiNR¹SiMe₃. The educt of the formula (4), for example BCl₃, is returned to the reactor. The final product is obtained in liquid form and may be discharged from the bottom of the reactor and, if necessary, purified by partial condensation, distillation or pervaporation.

The method according to the invention may in particular be used for the production of compounds which comprise the structural feature X—N—Y, in which X and Y may in each case independently be B, Al, Ga, In, Si, Ge, P, Ti, Zr, V, Nb, Ta, Cr, Mo, W, Fe or Zn. It is particularly preferably used for production of a compound which has the formula (1) RₓHal₃₋ₓSi—NR¹—BR_{y}Hal_{2-y}, in which Hal in each case independently means Cl, Br or I, R in each case independently represents a hydrocarbon residue with 1 to 20 C atoms or hydrogen, R¹ represents a hydrocarbon residue with 1 to 20 C atoms or hydrogen, x=0, 1 or 2 and y=0 or 1.

The desired products are preferably produced in a two-stage process. The compounds according to the formula (1) are for example produced by reacting a hexamethyldisilazane component (HMDS) Me₃SiNR¹SiMe₃ in succession in any desired order with a silane component SiHal₄₋ₓRₓ and a borane component BHal_{3-y}R_{y}. In the first step, the silane component, which is introduced in a gaseous state, is preferably caused to react in the gas phase or a gas phase-liquid phase reaction continuously or in portions, with or without a carrier gas, with the hexamethyldisilazane component, which is introduced in a liquid or gaseous state of aggregation. The intermediate formed is in turn preferably further reacted in the second step with the borane component in excess in an inert solvent, preferably in the gas phase or more preferably in pure condensed phase. Alternatively, the intermediate may be caused to react in a liquid state of aggregation with the borane component which is present in a gaseous state. Depending on p/T conditions, the target compound is obtained in pure form or mixed with the secondary product Me₃SiCl and the excess borane component and may be isolated with a phase separator. Using this reaction pathway, it is possible inter alia to produce the compounds MeCl₂SiNHBCl₂ (MADB) (1a), Cl₃SiNHBCl₂ (TADB) (1b), (CH₃)₂ClSiNHBCl₂ (DADB), Cl₃SiNCH₃BCl₂ (DMTA) or CH₃Cl₂SiNCH₃BCl₂ (DDMA) in pure form. In the case of MADB, methyltrichlorosilane, which is introduced in a gaseous state, and hexamethyidisilazane, which is introduced in a gaseous or liquid state of aggregation, are caused to react in the gas phase or in a gas phase-liquid phase reaction. In the case of TADB, tetrachlorosilane is used instead of methyltrichlorosilane, the reaction being carried out in analogous manner. The intermediates obtained are respectively MeCl₂SiNHSiMe₃ and Cl₃SiNHSiMe₃, which are in each case reacted in the gas phase or preferably in condensed form with gaseous trichloroborane.

In the formula RₓHal₃₋ₓSi—NR¹—BR_{y}Hal_{2-y} (1), the residues R and R¹ may in each case independently mean hydrogen or a hydrocarbon residue with 1 to 20 C atoms, preferably with 1 to 10 C atoms.

A hydrocarbon residue is here a residue which is formed from the elements carbon and hydrogen. According to the invention, hydrocarbon residues may be branched or unbranched, saturated or unsaturated. The hydrocarbon residue may also contain aromatic groups, which may in turn be substituted with hydrocarbon residues. Examples of preferred hydrocarbon residues are for example unbranched saturated hydrocarbon residues, such as for instance C₁ to C₂₀ alkyl, in particular methyl, ethyl, n-propyl, n-butyl, n-pentyl, n-hexyl, n-heptyl, n-octyl, n-nonyl and n-decyl. The residues R and/or R¹ may, however, also comprise branched saturated hydrocarbon residues, in particular branched C₃ to C₂₀ alkyls, such as for instance i-propyl, i-butyl, t-butyl and further branched alkyl residues. In one embodiment, the residues R and/or R¹ comprise one or more olefinically unsaturated groups. Examples of such residues are vinyl, allyl, butenyl, pentenyl, hexenyl, heptenyl, octenyl, nonenyl, decenyl, pentadienyl, heptadienyl, octadienyl, nonadienyl and decadienyl. The residues R and/or R¹ may also contain an alkyne group, thus a C≡C bond. In a further embodiment, at least one residue R and/or R¹, preferably all the residues R and/or R¹, contain(s) an aromatic group, in particular an aromatic group with 5 to 10 C atoms, in particular 5 or 6 C atoms, such as for instance a phenyl group or an aromatic group, in particular a phenyl group, substituted with a hydrocarbon, in particular a C₁ to C₁₀ hydrocarbon, such as for instance methylphenyl, dimethylphenyl, trimethylphenyl, ethylphenyl or propylphenyl. Including the substituents, the aromatic residue preferably comprises 5 to 20, in particular to 10 C atoms. The hydrocarbon residues R and R¹ may here in each case mutually independently be varied.

Preferably, at least one residue R and/or R¹ and in particular all the residues R and/or R¹ comprise(s) hydrogen, a C₁ to C₂₀ alkyl group, in particular a C₁ to C₆ alkyl group, a phenyl group, a vinyl group or an allyl group or a hydrocarbon residue with 1 to 3 C atoms, in particular methyl, ethyl or propyl and particularly preferably methyl.

The residue Hal denotes a halogen atom and in particular means Cl, Br or I, it being preferred for at least one Hal residue and preferably all Hal residues to mean Cl.

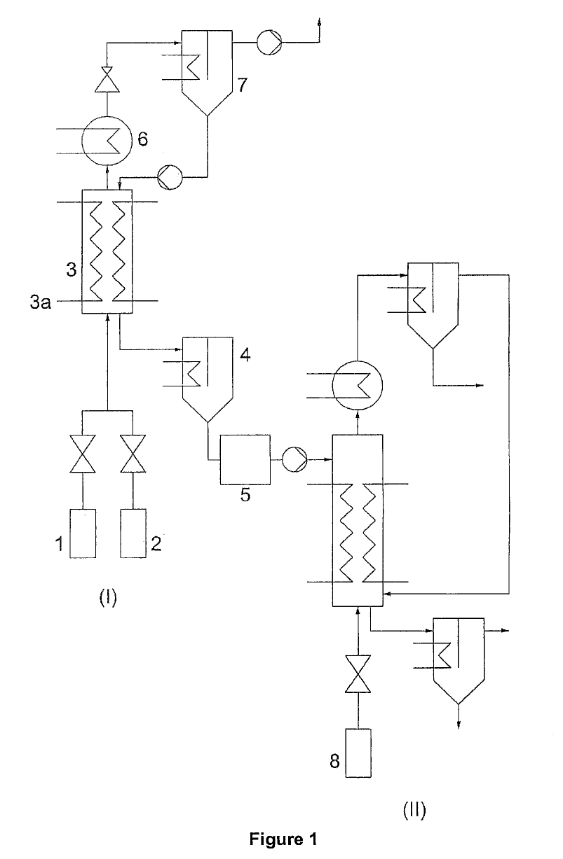

The invention is described in greater detail by the attached FIGS. 1-4 and the following Examples. FIGS. 1-4 are schematic diagrams of variants of the production plant for the two-stage method according to the present invention.

### EXAMPLES

### Example 1

### Synthesis of MADB (1a)

FIG. 1 shows the method flow chart according to one embodiment of the invention. The procedures in reaction stages I and II are independent of one another and are described sequentially.

MeSiCl₃ is apportioned from the temperature-controlled holding vessel 1 and HMDS from the temperature-controlled holding vessel 2 either pure or in an inert carrier case stream, for example N₂, He, Ar, CO₂, into the reactor 3. The feed materials are both jointly introduced pointwise, or both spatially distributed or one pointwise and one spatially distributed into the reactor 3 of the first reaction stage. Thanks to the nature of apportioning and flow control, a stoichiometric excess of MeSiCl₃ to HMDS of at least 2:1 is ensured throughout the entire reaction chamber.
Reactor temperature is controlled with the assistance of an external heat exchanger 3a to a temperature between −100° C. and 300° C., in particular between 25° C. and 100° C. The total pressure in the reactor 3 is between 0.1 mbar and 2 bar. Pressure and temperature are here adjusted relative to one another such that the partial pressures of the feed compounds MeSiCl₃ and HMDS are below their respective saturation vapour pressures, but the partial pressure of the intermediate MeCl₂SiNHSiMe₃ exceeds its saturation pressure. Under these conditions, the intermediate condenses, is discharged from the reaction volume via a phase separator 4 and directly supplied to the second reaction stage, alternatively it may be held in a buffer vessel 5. At the top of the reactor 3, the feed material MeSiCl₃ is condensed from the volatile components on a heat exchanger 6 and separated by means of a phase separator 7 from the secondary product Me₃SiCl. The temperature of the heat exchanger 6 is adjusted such that, at the given pressure, MeSiCl₃ exceeds its saturation vapour pressure, but Me₃SiCl is below its saturation vapour pressure. MeSiCl₃ is recirculated into the reactor. In steady-state operation, MeSiCl₃ and HMDS are replenished from the storage vessels 1 and 2 in the same molar quantity per unit time as the Me₃SiCl is removed from the reactor.
The intermediate from the first reaction stage is reacted in the second reaction stage with an excess of BCl₃, which is supplied from the temperature-controlled holding vessel 8. The second reaction stage may be of an analogous structure to the first stage, the reactor temperature being adjusted between −100° C. and +30° C. and the pressure set such that at least BCl₃ is in gaseous form, or may be carried out according to the prior art (DE 4 107 108, DE 10 045 428, DE 10 104 536). The final product is purified by phase separation.
The phase separators 4 and 7 may function by the principle of mechanical separation, for example inertial separators or cyclones. Thermal or physico-chemical separation methods may, however, also be used. Distillation/rectification or pervaporation may in particular be considered. The product yield of MADB amounts over both stages to at least 76% relative to the introduced HMDS. The product is characterised by mass spectrometry and nuclear magnetic resonance spectroscopy. MS (70 eV): m/z=196 (M⁺-CH₃), 174 (M⁺-HCl), 158 (M⁺-HCl-CH₃), 138 (M⁺-2HCl), ¹H-NMR: δ=0.47; 0.49; ¹³C-NMR: δ=6.3; 9.3; 128.4; ¹¹B-NMR: δ=36.4; 41.8.

### Example 2

### Synthesis of MADB (1a)

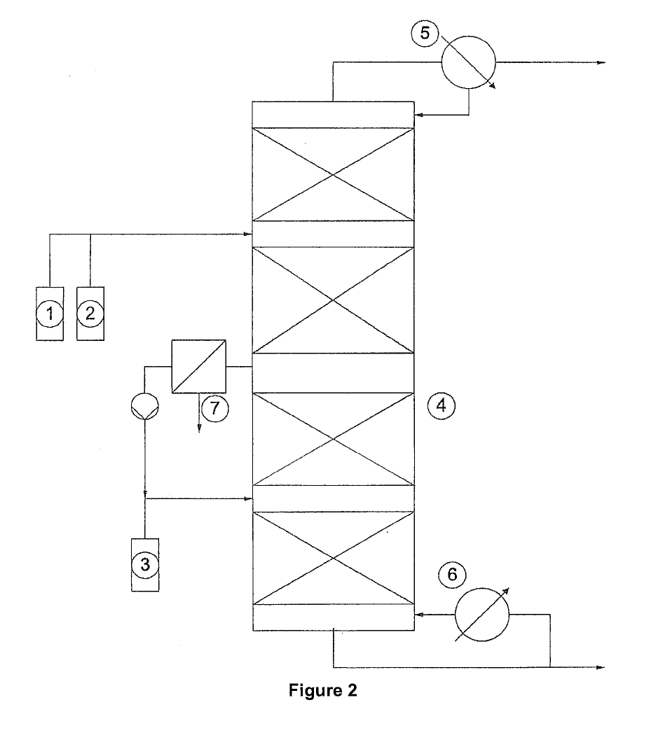

The boiling points of the educts, the intermediate, the secondary product and the final product are in a favourable ratio to one another, such that MADB may be synthesised by reactive distillation. FIG. 2 shows the diagram of this process variant. The process proceeds in a vacuum column 4. The educts of the first reaction stage are introduced into the rectification section together or at different positions 1 and 2. The highly volatile secondary product MeSiCl₃ is enriched towards the top of the column and the intermediate Cl₃SiNHSiMe₃ towards the exhausting section of the column. BCl₃ is separately introduced into the column via the inlet 3. The product is collected at the bottom of the column.

### Example 3

### Synthesis of TADB (1b)

Preparation of compound (1b) proceeds in analogous manner to the preparation of compound (1a) in Example 1, but using SiCl₄ and HMDS instead of MeSiCl₃ and HMDS as the educts. At the top of the reactor 3, unreacted SiCl₄ and secondary product Me₃SiCl leave the reaction chamber together in gaseous form, as they have the same vaporisation temperature. The SiCl₄/Me₃SiCl mixture is accordingly separated by means of a suitable separation stage 7 (membrane method with porous membranes or adsorption onto molecular sieves) and the sub-stream enriched with SiCl₄ is condensed in a total condenser 6 and recirculated into the first reaction stage. In steady-state operation, SiCl₄ and HMDS are resupplied to the process from the storage vessels 1 and 2 in a molar quantity per unit time which corresponds to the cumulated quantity of Me₃SiCl and discharged SiCl₄.

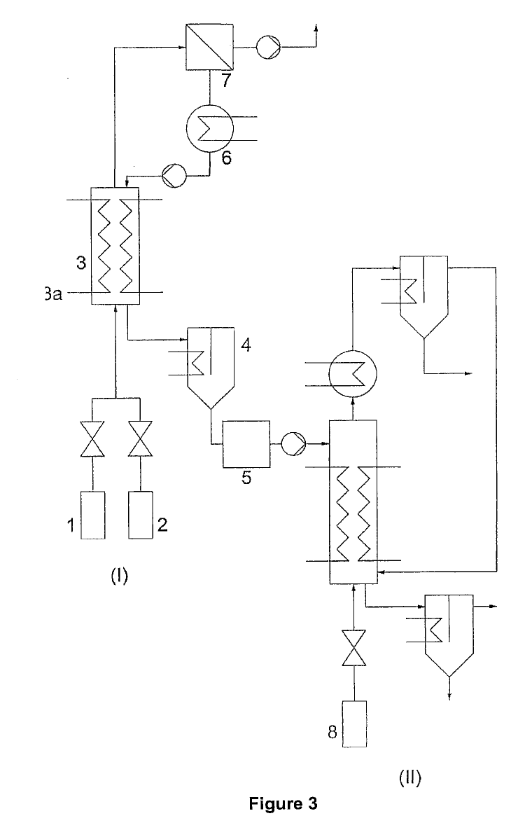

The product yield of TADB amounts over both stages to at least 85% relative to the introduced HMDS. The product is characterised by mass spectrometry and nuclear magnetic resonance spectroscopy. MS (70 eV): m/z=231 (M⁺), 196 (M⁺-Cl), 160 (M⁺-Cl-HCl); ¹H-NMR: δ=4.41; ¹¹B-NMR: δ=35.7; ²⁹Si-NMR: δ=−23.7.
FIG. 3 shows the method flow chart according to the described embodiment of the invention.

### Example 4

### Synthesis of TADB (1b)

Preparation of compound (1b) proceeds in analogous manner to the preparation of compound (1a) in Example 2 (FIG. 2), but using SiCl₄ and HMDS instead of MeSiCl₃ and HMDS as the educts. Moreover, the educts for the first reaction stage are preferably introduced into the rectification section at different positions 1 and 2. Due to its higher boiling point, the feed material HMDS is introduced into the rectification section above the feed material SiCl₄.

### Example 5

### Synthesis of TADB (1b)

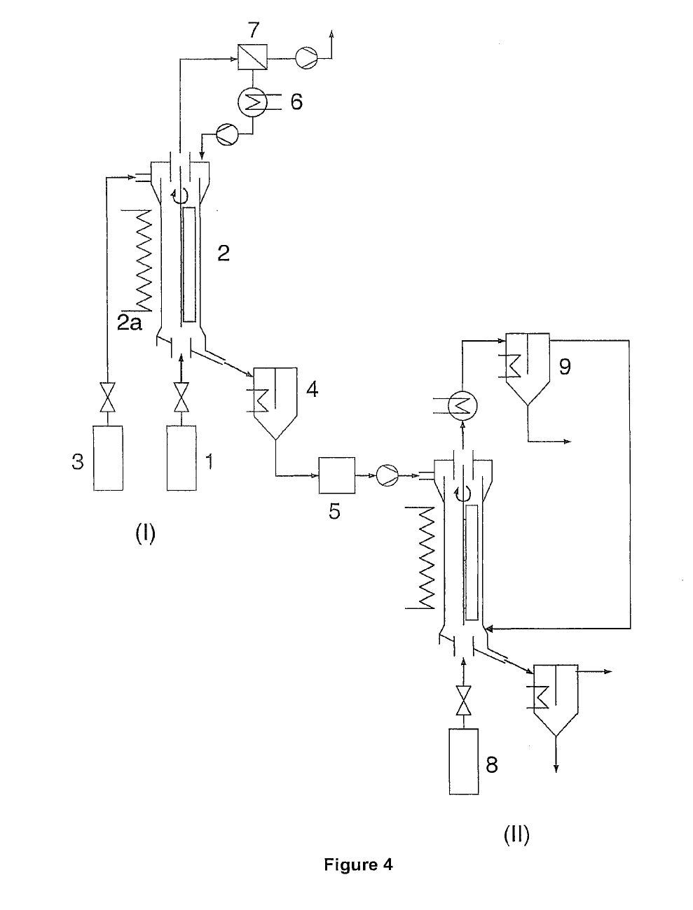

FIG. 4 shows the method flow chart according to an embodiment of the invention. The procedures in reaction stages (I) and (II) are independent of one another and are described sequentially.

SiCl₄ is apportioned from a temperature-controlled holding vessel 1 either pure or in an inert carrier gas stream, for example N₂, He, Ar, CO₂, into the lower part of the reactor of the first reaction stage 2 (for example falling-film reactor). HMDS is apportioned in liquid form from the storage vessel 3 into the top of the reactor and reacts countercurrently with gaseous SiCl₄. The molar flow rates of the two reactants are controlled such that a stoichiometric excess of SiCl₄ to HMDS of 1.2 to 1.5 is maintained in the reaction chamber.

Reactor temperature is controlled between −50° C. and 200° C. with the assistance of a external heat exchanger 2a. The total pressure in the reactor 2 is between 1 mbar and 1 bar. Pressure and temperature are here adjusted relative to one another such that the partial pressures of the feed compound SiCl₄ and of the secondary product MeSiCl₃ are below their respective saturation vapour pressures, but HMDS and the intermediate Cl₃SiNHSiMe₃ are in liquid form. This is the case, for example, with the combination 60° C./300 mbar. The intermediate is discharged in liquid form at the bottom of the falling-film reactor and directly supplied to the second reaction stage. Alternatively, the intermediate may be held in a buffer vessel 5. At the top of the reactor 2, unreacted SiCl₄ and secondary product Me₃SiCl leave the reaction chamber together in gaseous form, as they have virtually the same vaporisation temperature. The further treatment thereof proceeds as described in Example 3.

The intermediate from the first reaction stage is reacted in the second reaction stage with an excess (1.1-1.5 times) of BCl₃, which is supplied from the temperature-controlled holding vessel 8. The second reaction stage may be of an analogous structure to the first, but may also take the form of a plate column, temperature and pressure conditions being adjusted relative to one another such that feed material BCl₃ is in gaseous form and the secondary product Me₃SiCl is in gaseous or liquid form, while the intermediate stage Cl₃SiNHSiMe₃ and the final product Cl₃SiNHBCl₂ (TADB) are in liquid form. Excess BCl₃ and the secondary product Me₃SiCl are discharged in gaseous form from the top of the reactor and separated with a phase separator. Recovered BCl₃ is supplied, for example, to the holding vessel 8, while Me₃SiCl is recirculated into the production of the feed material HMDS. The final product is purified by phase separation and optionally separated from the secondary product Me₃SiCl.

The phase separators 4 and 9 may function by the principle of mechanical separation, for example inertial separators or cyclones. Thermal or physico-chemical separation methods may, however, also be used. Distillation/rectification or pervaporation may in particular be considered.

The product yield of TADB amounts over both stages to at least 84% relative to the introduced HMDS. The product is characterised by mass spectrometry and nuclear magnetic resonance spectroscopy (see Example 3).

1. A silazane cleavage method, characterised in that it is carried out continuously.

2. A method according to claim 1, characterised in that at least one the educts is introduced in gaseous form.

3. A method according to claim 1, characterised in that one educt in the liquid phase is reacted with a second educt in the gaseous phase.

4. A method according to claim 1, characterised in that all the educts are introduced in gaseous form.

5. A method according to claim 1, characterised in that a silazane compound is reacted with at least one compound of the formula (2) selected from
BHal₃₋ₓRₓ, AlHal₃₋ₓRₓ, GaHal₃₋ₓRₓ, InHal_{3-X}Rₓ, SiHal_{4-y}R_{y}, GeHal_{4-y}R_{y}, PHal₃₋ₓRₓ, PHal_{5-Z}R_{Z}, TiHal_{4-y}R_{y}, ZrHal_{4-y}R_{y}, VHal₃₋ₓRₓ, VHal_{4-y}R_{y}, NbHal_{5-z}R_{Z}, TaHal_{5-Z}R_{Z}, CrHal₃₋ₓRₓ, MoHal_{4-y}R_{y}, MoHal_{5-Z}R_{Z}, WHal_{6-Z}R_{z}, FeHal₃₋ₓRₓ or ZnCl₂ in which x=0 or 1, y=0, 1 or 2 and z=0, 1, 2 or 3, Hal is selected from F, Cl, Br and I, and R represents hydrogen or a hydrocarbon residue with 1 to 20 C atoms.

6. A method according to claim 1, characterised in that the target product of the reaction is removed from the reaction mixture.

7. A method according to claim 1, characterised in that one of the educts is introduced in excess.

8. A continuous method comprising silazane cleavage according to claim 1 for the production of a compound which comprises the structural feature N—Y, in which Y is in each case independently selected from B, Al, Ga, In, Si, Ge, P, Ti, Zr, V, Nb, Ta, Cr, Mo, W, Fe or Zn, wherein a silazane compound is reacted with a compound of the formula (2) selected from
BHal₃₋ₓRₓ, AlHal₃₋ₓRₓ, GaHal₃₋ₓRₓ, InHal_{3-X}Rₓ, SiHal_{4-y}R_{y}, GeHal_{4-y}R_{y}, PHal₃₋ₓRₓ, PHal_{5-Z}R_{Z}, TiHal_{4-y}R_{y}, ZrHal_{4-y}R_{y}, VHal₃₋ₓRₓ, VHal_{4-y}R_{y}, NbHal_{5-z}R_{Z}, TaHal_{5-Z}R_{Z}, CrHal₃₋ₓRₓ, MoHal_{4-y}R_{y}, MoHal_{5-Z}R_{Z}, WHal_{6-Z}R_{z}, FeHal₃₋ₓRₓ or ZnCl₂ in which x=0 or 1, y=0, 1 or 2 and z=0, 1, 2 or 3, Hal is selected from F, Cl, Br and I, and R represents hydrogen or a hydrocarbon residue with 1 to 20 C atoms.

9. A continuous method comprising two silazane cleavage reactions according to claim 1 for the production of a compound which comprises the structural feature X—N—Y, in which X and Y are in each case independently selected from B, Al, Ga, In, Si, Ge, P, Ti, Zr, V, Nb, Ta Cr, Mo, W, Fe or Zn,
comprising the steps
reacting a compound of the formula (3)
R²₃SiNR¹Si R³₃,
in which R² and R³ in each case mutually independently represent a hydrocarbon residue with 1-20 carbon atoms and R¹ represents hydrogen or a hydrocarbon residue with 1-20 C atoms, in succession in any desired order with a compound of the formula (2) selected from
BHal₃₋ₓRₓ, AlHal₃₋ₓRₓ, GaHal₃₋ₓRₓ, InHal₃₋ₓRₓ, SiHal_{4-y}R_{y}, GeHal_{4-y}R_{y}, PHal₃₋ₓRₓ, PHal_{5-Z}R_{Z}, TiHal_{4-y}R_{y}, ZrHal_{4-y}R_{y}, VHal₃₋ₓRₓ, VHal_{4-y}R_{y}, NbHal_{5-z}R_{z}, TaHal_{5-Z}R_{Z}, CrHal₃₋ₓRₓ, MoHal_{4-y}R_{y}, MoHal_{5-Z}R_{Z}, WHal_{6-Z}R_{Z}, FeHal₃₋ₓRₓ or ZnCl₂ in which x=0 or 1, y=0, 1 or 2 and z=0, 1, 2 or 3, Hal is selected from F, Cl, Br and I, and R represents hydrogen or a hydrocarbon residue with 1 to 20 C atoms, and a compound of the formula (4) selected from
BHal₃₋ₓRₓ, AlHal₃₋ₓRₓ, GaHal₃₋ₓRₓ, InHal_{3-X}Rₓ, SiHal_{4-y}R_{y}, GeHal_{4-y}R_{y}, PHal₃₋ₓRₓ, PHal_{5-Z}R_{Z}, TiHal_{4-y}R_{y}, ZrHal_{4-y}R_{y}, VHal₃₋ₓRₓ, VHal_{4-y}R_{y}, NbHal_{5-z}R_{Z}, TaHal_{5-Z}R_{Z}, CrHal₃₋ₓRₓ, MoHal_{4-y}R_{y}, MoHal_{5-Z}R_{Z}, WHal_{6-Z}R_{z}, FeHal₃₋ₓRₓ or ZnCl₂ in which x=0 or 1, y=0, 1 or 2 and z=0, 1, 2 or 3, Hal is selected from F, Cl, Br and I, and R represents hydrogen or a hydrocarbon residue with 1-20 C atoms.

10. A method according to claim 1, characterised in that the product formed is a molecular single component precursor for non-oxide ceramics.

11. A method according to claim 1, characterised in that a compound of the formula (1) R_{X} Hal₃₋ₓSi—NR¹—BR_{y} Hal_{2-y} is produced, wherein SiHal_{4-y}R_{y} is used as the compound of the formula (2) and BHal₃₋ₓR_{X} is used as the compound of the formula (4).

12. A method according to claim 1, characterised in that the reaction is carried out at temperatures of −100° C. to 300° C. and/or a pressure of 0.1 mbar to 2 bar.

13. A method according to claim 1, characterised in that pressure and temperature are adjusted such that the educts are in gaseous form, but the intermediate and final product are in liquid form.

14. A method according to claim 1, characterised in that the reaction with compounds of the formula (2) is carried out at a temperature of >25° C., in particular ≧50° C.

15. A method according to claim 1, characterised in that the silazane compound is reacted with an excess of compounds of the formula (2).

16. A method according to claim 1, characterised in that R₃SiHal is separated as secondary product from the method.

17. A method according to claim 1, characterised in that pressure and temperature are adjusted such that the partial pressure of a secondary product of the formula (5) formed during the reaction R₃SiHal is lower than the saturation vapour pressure thereof, in which Hal in each case independently means Cl, Br or I, R in each case independently represents a hydrocarbon residue with 1 to 20 C atoms or hydrogen,
x=0, 1 or 2 and y=0 or 1.

18. A method according to claim 1, characterised in that a compound of the formula (3) is reacted first with a compound of the formula (2) and thereafter in a further stage with a compound of the formula (4).

19. A method according to claim 9, characterised in that the reaction of the compound of the formula (3) with the compound of the formula (2) is carried out under pressure and temperature conditions, under which the educts are in gaseous form and the intermediate condenses as a liquid, the intermediate being separated in liquid form.

20. A method according to claim 19, characterised in that the reaction of the compound of the formula (3) with the compound of the formula (2) is carried out under pressure and temperature conditions, under which the educt of the formula (3) is in gaseous form, while the educt of the formula (2) and the intermediate are in liquid form.

21. A method according to claim 1, characterised in that the compound CH₃Cl₂SiNHBCl₂ (MADB), Cl₃SiNHBCl₂ (TADB), (CH₃) ₂ClSiNHBCl₂ (DADB), Cl₃SiNCH₃BCl₂ (DMTA) or CH₃Cl₂SiNCH₃BCl₂ (DDMA) is produced.
